(19) United States
(12) Patent Application Publication
(10) Pub. No.: US 2020/0086966 A1
(43) Pub. Date: Mar. 19, 2020

(54) AIRCRAFT FLOORING SYSTEMS AND RELATED METHODS

(71) Applicant: Harper Engineering Co., Renton, WA (US)

(72) Inventor: David Chadwell, Renton, WA (US)

(21) Appl. No.: 16/548,527

(22) Filed: Aug. 22, 2019

Related U.S. Application Data
(60) Provisional application No. 62/732,820, filed on Sep. 18, 2018.

(51) Int. Cl. B64C 1/18; B64D 11/06; B64D 41/00

(52) U.S. Cl. CPC B64C 1/18; B64D 2221/00; B64D 41/00; B64D 11/0696

(57) ABSTRACT

An aircraft flooring system includes a floor beam, a seat track having a base flange, the base flange including a plurality of apertures, where the one or more of the apertures have a diamond-shaped profile, a seat track fitting coupleable to the seat track via the diamond-shaped profile of the plurality of apertures of the seat track, and a first floor panel. The aircraft flooring system also includes an edge panel that is sized and shaped to couple the first floor panel to the seat track. Related methods, devices, and apparatuses are also provided.

### BACKGROUND

### Technical Field

The present disclosure generally relates to flooring systems, and more particularly to aircraft interior flooring systems.

### Description of the Related Art

An aircraft floor structure is generally constructed in a grid formation. In the longitudinal direction (i.e., forward-aft direction of an aircraft fuselage), the floor structure may include a plurality of seat tracks spaced apart in the lateral direction (i.e., the left-right direction of the aircraft fuselage with respect to its longitudinal or roll axis). The seat tracks are typically mounted on floor beams, which generally extend in the lateral direction from one side of the aircraft fuselage body to the other. The floor beams are typically spaced apart in the longitudinal direction (i.e., forward-aft direction of the aircraft fuselage). A plurality of floor panels are coupled to the top of the floor structure, the floor panels generally being disposed between adjacent seat tracks.

Conventional seat tracks are generally manufactured with an extrusion that has a generally flat base flange and one or more chord flanges, with each chord flange a mirror image of the other about a central vertical axis. The chord flanges generally have an L-shaped or T-shaped cross section having a web or upstanding flange and a perpendicular lower flange. The floor beams are generally coupled to the chord flanges.

Conventional seat tracks typically include a channel disposed in the base flange that extends in a longitudinal direction and is defined by a plurality of longitudinally spaced apart recesses. The channels in the base flange of the seat tracks are generally configured to couple to seats. For example, aircraft seats are coupled to the seat tracks via seat track fittings positioned in the channels. Manufacturing seat tracks involves complex, costly processes, including machining the channels, and providing sufficient tolerances. Further, installation of seat track fittings is labor-intensive and time consuming. For example, positioning the seat track fittings in the channels is labor-intensive, time consuming, and is significantly dependent on maintaining manufacturing tolerances with a high level of precision. Thus, a simplified design and simplicity of installation is desirable.

As described above, floor panels are generally coupled at the top of the floor structure or floor grid. More particularly, the floor panels are coupled to the base flange of seat tracks via fasteners. The fasteners are generally used to couple the floor panels to the seat track to react shear loads. Such a configuration is not only expensive because of the numerous fasteners that are required, but time consuming, and results in a significant impact on the overall weight footprint of an aircraft flooring grid because of the weight of the fasteners. It is therefore desirable to increase efficiencies of flooring systems by, in part, improving installation processes, and reducing the number of fasteners and the overall weight footprint of an aircraft interior.

### BRIEF SUMMARY

Various implementations of aircraft flooring systems described herein have compact, efficient, and robust form factors that improve the weight footprint of an aircraft, simplify installation/uninstallation processes, and reduce complexity and costs of manufacturing. For example, in one example implementation, an aircraft flooring system can be summarized as including a floor beam, a seat track having a base flange, the base flange including a plurality of apertures, with one or more of the apertures having a diamond-shaped profile, a seat track fitting coupleable to the seat track via the diamond-shaped profile of the plurality of apertures of the seat track. The aircraft flooring system can further include a first floor panel, and an edge panel that is sized and shaped to couple the first floor panel to the seat track.

For example, in another example implementation, an aircraft flooring system can be summarized as including a seat track having a base flange, a first chord flange and a second chord flange, with the first chord flange being a mirror image of the second chord flange relative to a central vertical axis of the seat track, the first chord flange and the second chord flange coupled to the base flange, a first retention flange and a second retention flange, with the first retention flange being a mirror image of the second retention flange relative to the central vertical axis of the seat track, the first retention flange and the second retention flange each protruding outwardly from the respective first chord flange and the second chord flange. The aircraft flooring system can also include a first floor panel, a second floor panel, a first edge panel that is sized and shaped to couple the first floor panel to the first retention flange of the seat track, and a second edge panel that is sized and shaped to couple the second floor panel to the second retention flange of the seat track.

For example, in another example implementation, a seat track of an aircraft flooring system can be summarized as including a base flange having a plurality of diamond-shaped apertures, a first chord flange including a first upstanding flange and a first lower flange, the first upstanding flange extending from the base flange, and a second chord flange including a second upstanding flange and a second lower flange, the second upstanding flange extending from the base flange. The seat track can also include a first retention flange extending outwardly from the first upstanding flange, and a second retention flange extending outwardly from the second upstanding flange.

For example, in another example implementation, an edge panel of an aircraft flooring system can be summarized as including a connecting flange, a web flange extending from the connecting flange, and a panel flange extending outwardly from an end of the web flange. The panel flange can include a first surface and a second surface, the first surface including a plurality of spaced apart panel protrusions protruding outwardly from the first surface.

For example, in another example implementation, a method of construction an aircraft flooring grid can be summarized as including providing at least one floor beam, coupling at least one seat track to the floor beam, the at least one seat track including a base flange, with the base flange including a plurality of apertures, one or more of the apertures having a diamond-shaped profile, coupling at least one edge panel to the at least one seat track. The method can also include coupling at least one floor panel to the at least one seat track via the at least one edge panel, and coupling a seat track fitting to the base flange of the at least one seat track via one or more of the apertures of the seat track having the diamond-shaped profile.

### BRIEF DESCRIPTION OF THE SEVERAL VIEWS OF THE DRAWINGS

FIG. 1 is a perspective view of a flooring system, according to one example, non-limiting implementation.

FIG. 2 is a partially exploded view of the flooring system of FIG. 1, with certain components removed for clarity of illustration and description.

FIG. 3 is a perspective view of a seat track of the flooring system of FIG. 1, according to one example, non-limiting implementation.

FIG. 4 is a side view of the seat track of the flooring system of FIG. 1.

FIG. 5 is a front view of the seat track of the flooring system of FIG. 1.

FIG. 6 is a perspective view of a seat track fitting of the flooring system of FIG. 1, according to one example, non-limiting implementation.

FIG. 7 is a side view of the seat track fitting of the flooring system of FIG. 1, illustrated in FIG. 6.

FIG. 8 is a rear view of the seat track fitting of the flooring system of FIG. 1, illustrated in FIG. 6.

FIG. 9 is a cross-sectional view of the seat track fitting of the flooring system of FIG. 1, illustrated in FIG. 6, taken along lines 9-9.

FIG. 10 is a perspective view of another seat track fitting of the flooring system of FIG. 1, according to one example, non-limiting implementation.

FIG. 11 is a side view of the seat track fitting of the flooring system of FIG. 1, illustrated in FIG. 10.

FIG. 12 is a rear view of the seat track fitting of the flooring system of FIG. 1, illustrated in FIG. 10.

FIG. 13 is a cross-sectional view of the seat track fitting of the flooring system of FIG. 1, illustrated in FIG. 10, taken along lines 13-13.

FIG. 14 is a perspective view of an edge panel of the flooring system of FIG. 1, according to one example, non-limiting implementation.

FIG. 15 is a front view of the edge panel of the flooring system of FIG. 1.

FIG. 16 is a side view of the edge panel of the flooring system of FIG. 1.

FIG. 17 is another skewed perspective view of the edge panel of the flooring system of FIG. 1.

FIG. 18 is a skewed perspective view of a floor panel of the flooring system of FIG. 1, according to one example, non-limiting implementation.

FIG. 19 is a side view of the flooring system of FIG. 1, with certain components removed for clarity of illustration and description.

FIG. 20 is a rear view of the flooring system of FIG. 1, with certain components removed for clarity of illustration and description.

FIG. 21 is a cross-sectional view of the flooring system of FIG. 1, taken along lines 21-21, with certain components removed for clarity of illustration and description.

FIG. 22 is a cross-sectional view of the flooring system of FIG. 1, taken along lines 22-22, with certain components removed for clarity of illustration and description.

FIG. 23 is a cross-sectional view of the flooring system of FIG. 1, taken along lines 23-23, with certain components removed for clarity of illustration and description.

FIG. 24 is a cross-sectional view of the flooring system of FIG. 1, taken along lines 24-24, with certain components removed for clarity of illustration and description.

FIG. 25 is a perspective view of a flooring system, according to one example, non-limiting implementation.

FIG. 26 is a partially exploded view of the flooring system of FIG. 25 with certain components removed for clarity of illustration and description.

FIG. 27 is a side view of the flooring system of FIG. 25, with certain components removed for clarity of illustration and description.

FIG. 28 is a rear view of the flooring system of FIG. 25, with certain components removed for clarity of illustration and description.

FIG. 29 is a perspective view of a wiring edge panel of the flooring system of FIG. 25, according to one example, non-limiting implementation.

FIG. 30 is a side view of a wiring edge panel of the flooring system of FIG. 25, according to one example, non-limiting implementation.

FIG. 31 is a front view of a wiring edge panel of the flooring system of FIG. 25, according to one example, non-limiting implementation

### DETAILED DESCRIPTION

In the following description, certain specific details are set forth in order to provide a thorough understanding of various disclosed embodiments or implementations. However, one skilled in the relevant art will recognize that embodiments or implementations may be practiced without one or more of these specific details, or with other methods, components, materials, etc. In other instances, well-known structures associated with payload components, flooring systems and components thereof, payload attachment mechanisms, and payload attachment structures of aircrafts have not been shown or described in detail to avoid unnecessarily obscuring descriptions of the embodiments. In addition, although the foregoing and following description of various embodiments or implementations describe or reference aircraft seats as an example of a payload component, other examples of payload components are within the scope of the disclosed subject matter.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment,” “one implementation,” “an embodiment,” or “an implementation” means that a particular feature, structure or characteristic described in connection with the embodiment or implementation is included in at least one embodiment or implementation. Thus, the appearances of the phrases “in one embodiment,” “in one implementation,” “in an embodiment,” or “in an implementation” in various places throughout this specification are not necessarily all referring to the same embodiment or implementation. Furthermore, the particular features, structures, or characteristics may be combined in any suitable manner in one or more embodiments or implementations.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

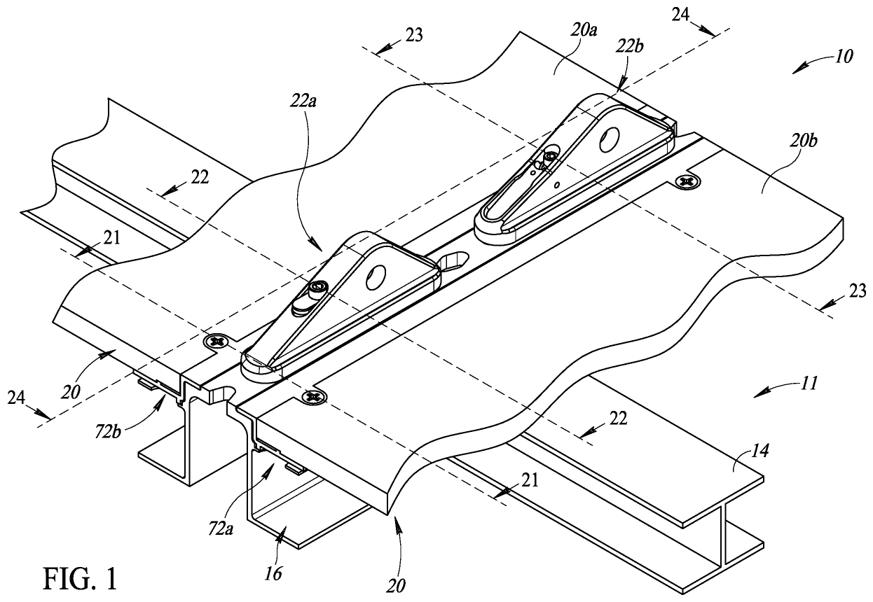

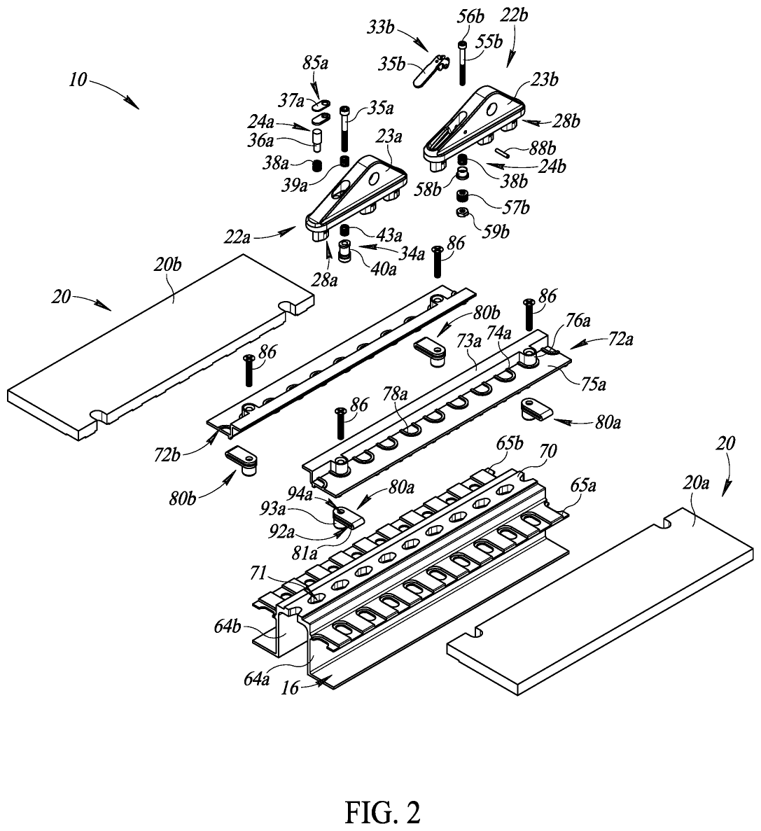

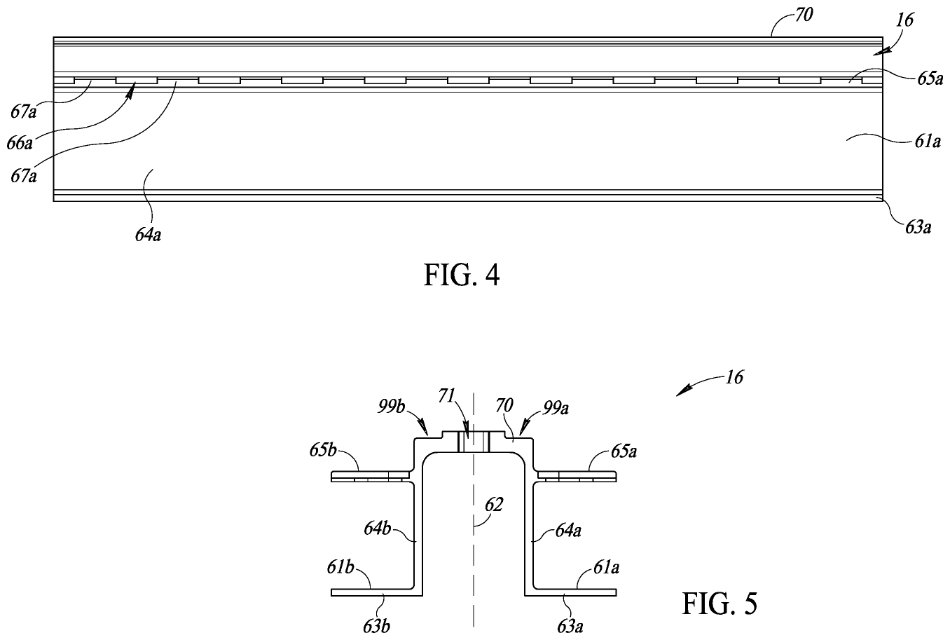

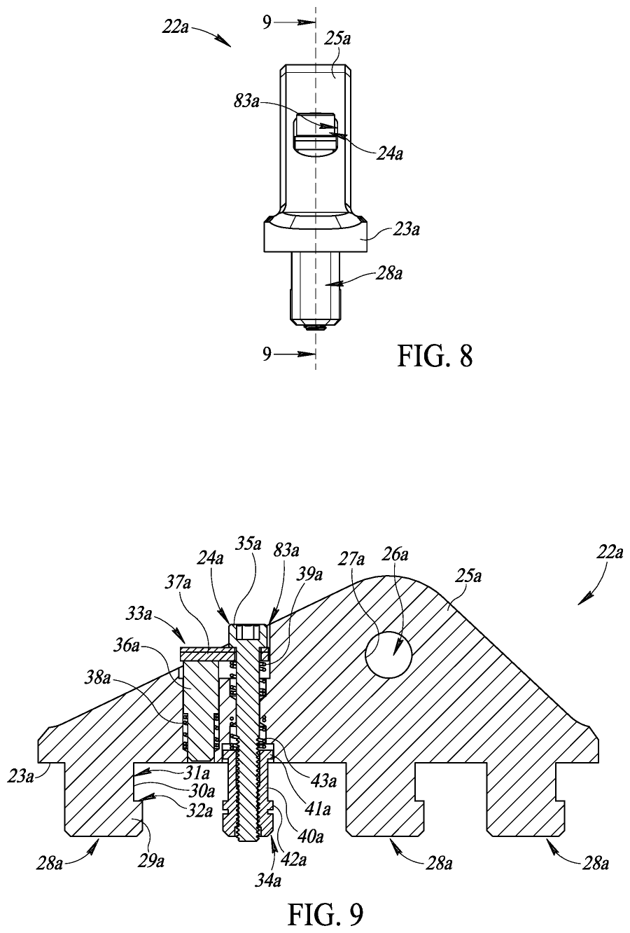

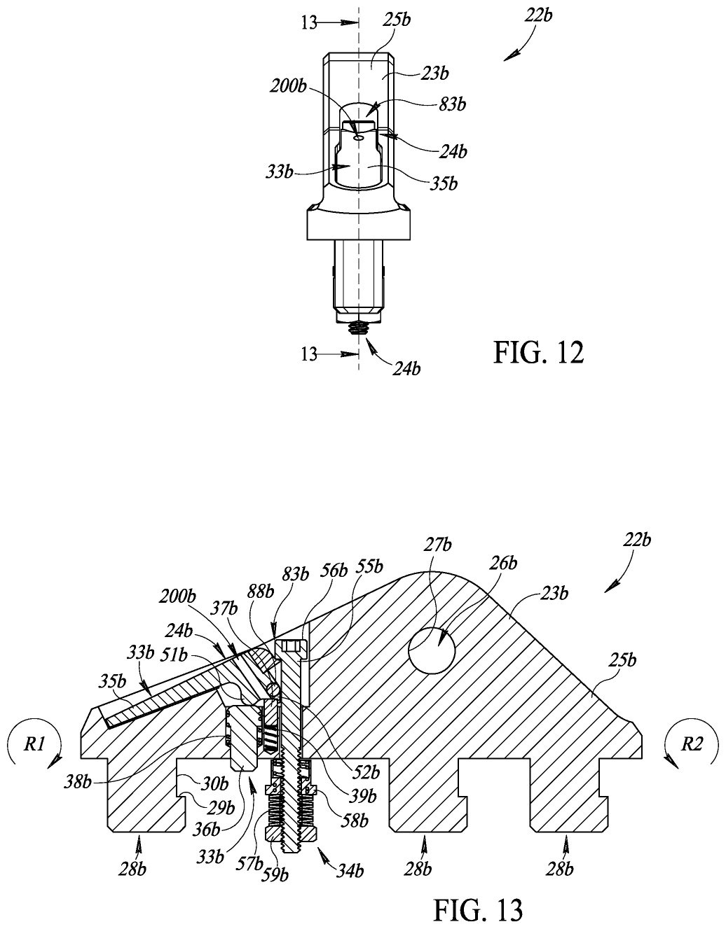

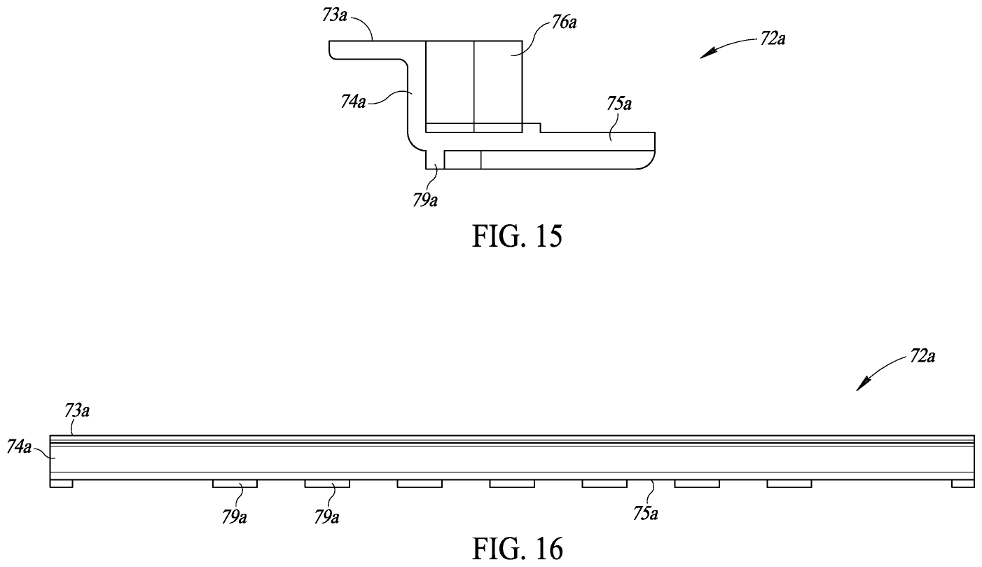

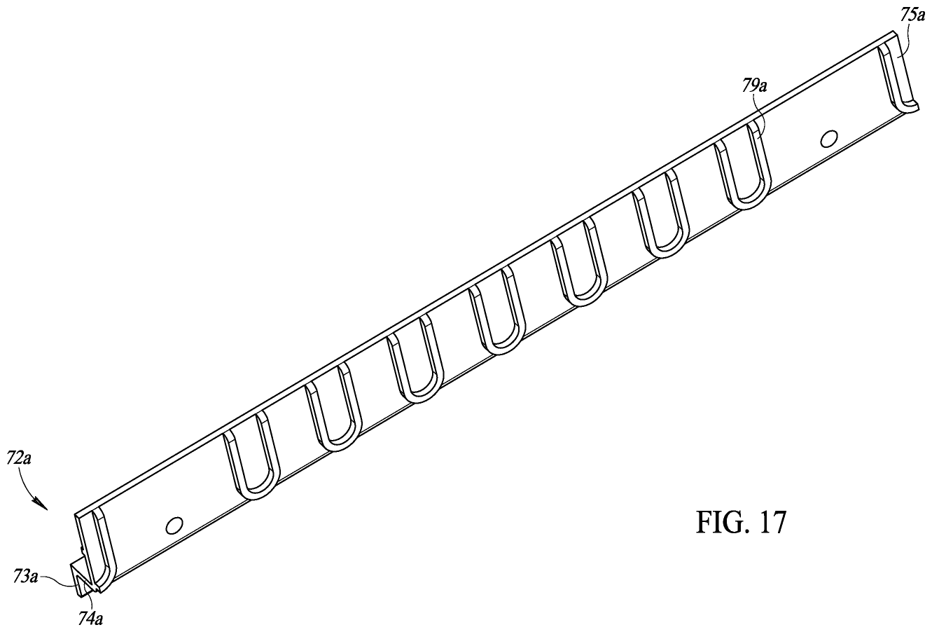

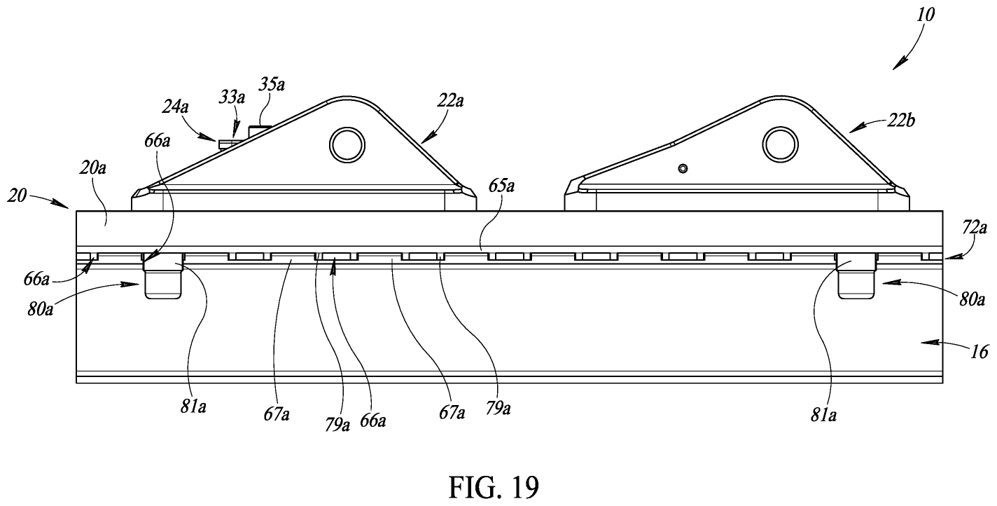

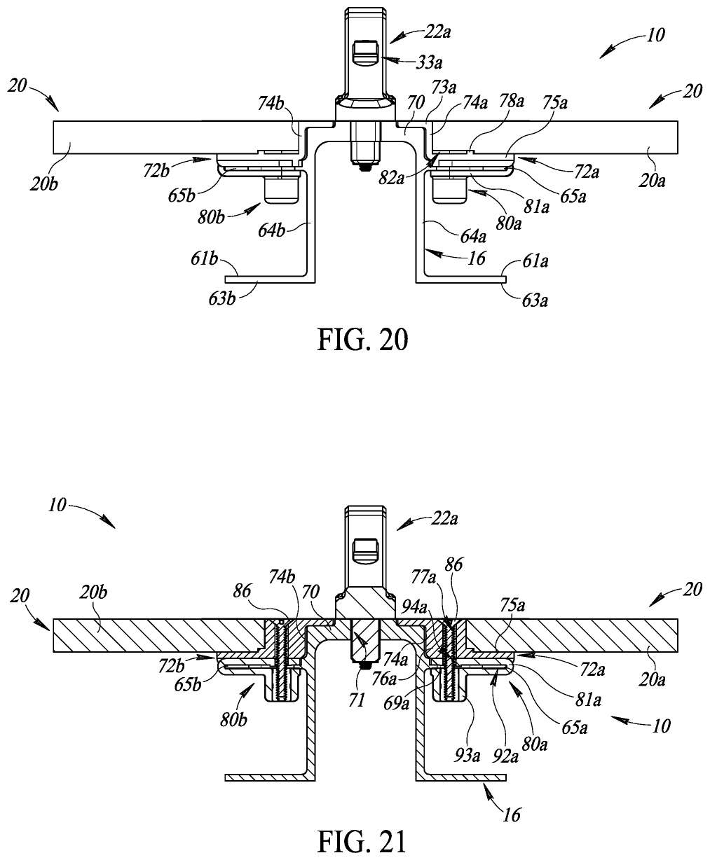

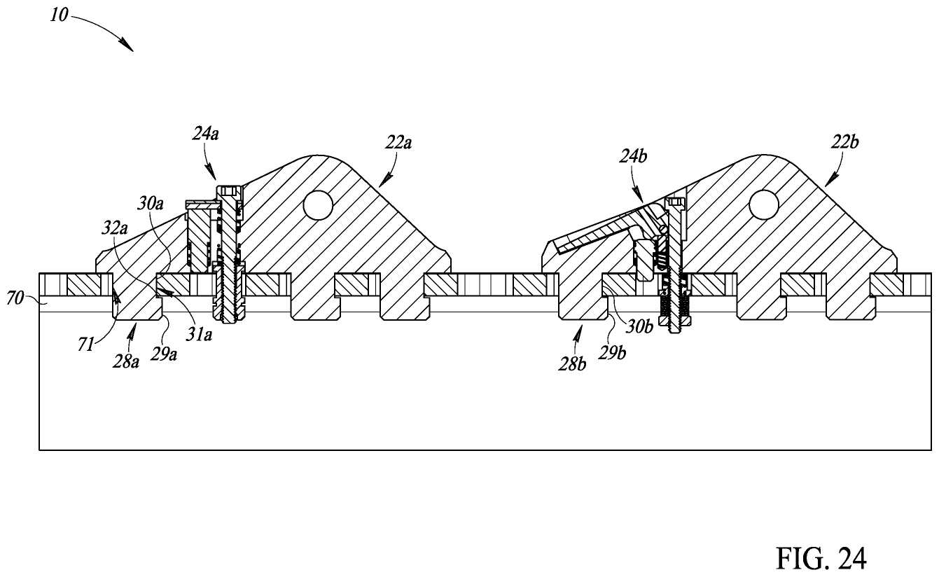

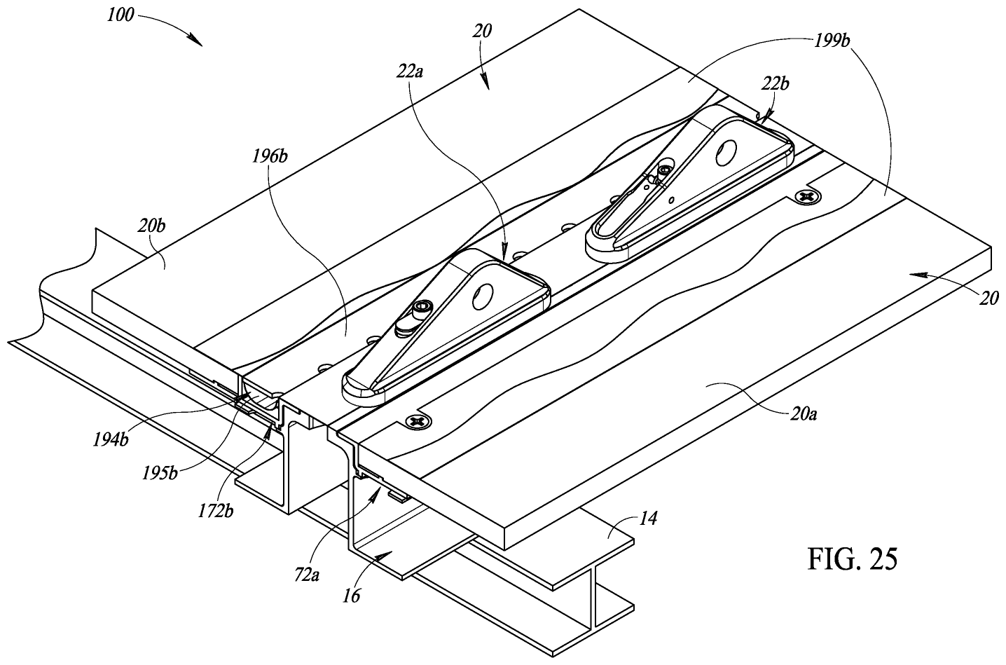

FIGS. 1-24 generally illustrate a flooring system 10, or portions thereof, according to one example, non-limiting implementation. In general, a flooring system, e.g., flooring system 10, of an aircraft includes a plurality of floor beams 14, which are spaced apart (only one shown for clarity of illustration and description), and extending laterally with respect to an aircraft fuselage longitudinal or roll axis, e.g., left-right direction, and a plurality of seat tracks 16 (only one shown for clarity of illustration and description) extending longitudinally with respect to the aircraft fuselage, e.g., forward-aft direction or parallel to the fuselage longitudinal or roll axis, to define a flooring grid 11. A plurality of floor panels 20 are secured to the seat tracks 16. The floor panels 20 may extend in the lateral direction between a pair of adjacent seat tracks 16 or may extend laterally between multiple adjacent seat tracks 16. In the interest of clarity of illustration and description, the floor beams 14 are not shown in FIGS. 2-24. However, a person skilled in the relevant art will understand, upon review of the disclosed subject matter, that a flooring system 10 may have multiple floor beams 14 which are coupled to the seat tracks 16.

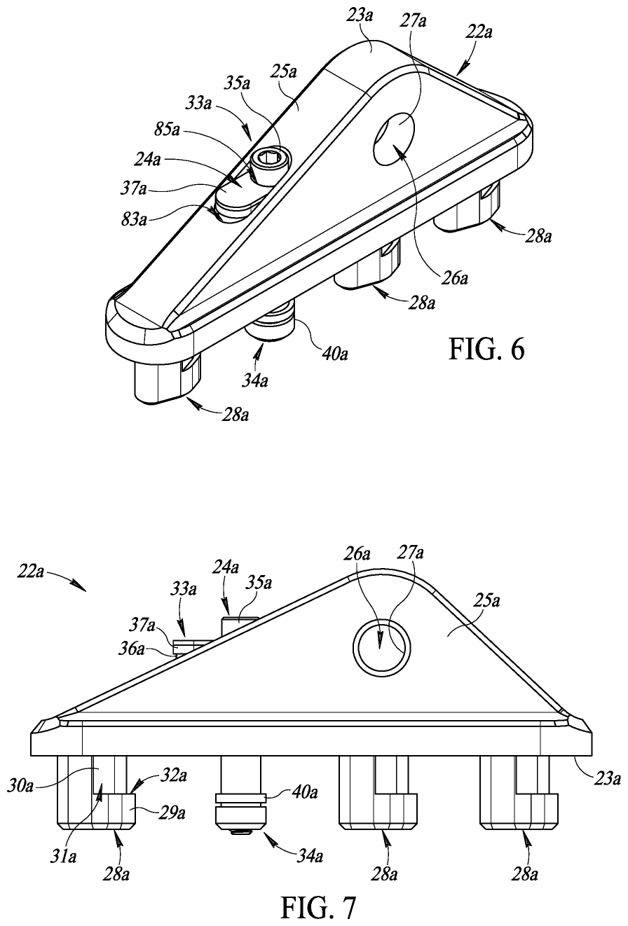

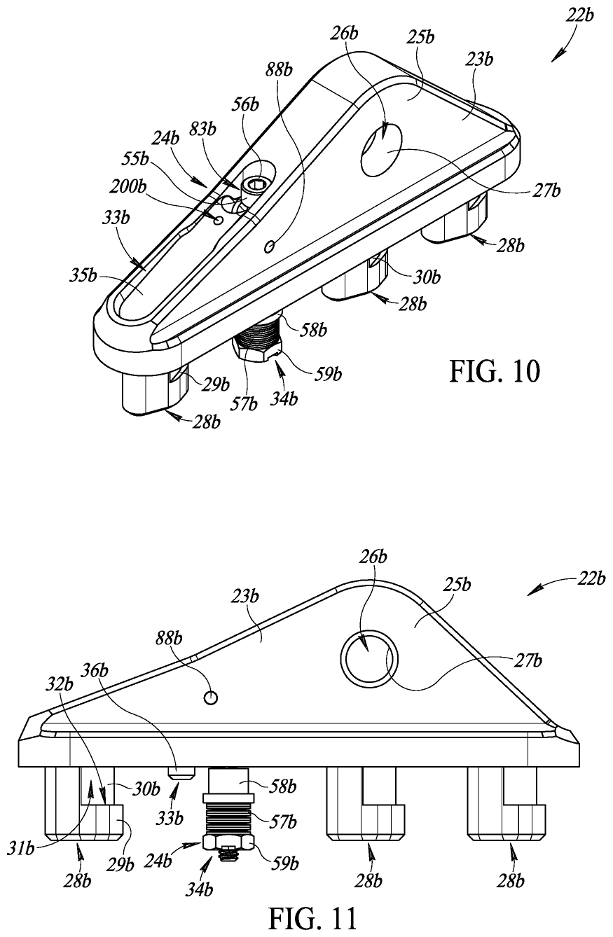

In general, a flooring grid 11 is constructed to provide structural strength and stability to the aircraft fuselage and payload components that may be mounted thereon. For example, payload components, such as aircraft seats, are coupled to the flooring grid 11, via seat tracking fittings, e.g., seat track fittings 22a, 22b, of the flooring system 10. The seat track fittings can take a wide variety of forms and shapes. For example, the implementation of the flooring system 10 demonstrates at least a pair of seat track fittings 22a, 22b. FIGS. 6 through 9 illustrate detail views of the seat track fitting 22a, and FIGS. 10-13 illustrate detail views of the seat track fitting 22b.

With reference to FIGS. 6-9 and continued reference to FIGS. 1-2 and 19-24, the seat track fitting 22a includes a seat track fitting body 23a and a retention mechanism 24a. The seat track fitting body 23a includes a central flange 25a that has a substantially triangular shape and includes a payload aperture 26a that extends through a lug portion 27a. In general, the central flange 25a can have other sizes, shapes and forms that may be selected appropriately based on a payload component that has to be coupled to the seat track fitting 22a. Similarly, the size, shape, and positioning of the payload aperture 26a can be selected appropriately based on the payload component that has to be coupled to the seat track fitting 22a.

The seat track fitting body 23a includes a plurality of spaced apart shear pads 28a. A number of shear pads 28a protrude outwardly from a lower surface of the seat track fitting body 23a. Unlike conventional shear pads that protrude outwardly from both sides of central flanges, the shear pads 28a protrude from the lower surface of the seat track fitting body 23a and have a substantially diamond-shape profile as viewed looking up toward the lower surface of the seat track fitting body 23a. Each shear pad 28a includes an integrally formed tensile flange 29a and a shear flange 30a. The shear flange 30a includes a side surface 31a, and the tensile flange 29a includes a tensile surface 32a. As will be described in more detail below, the tensile flange 29a is sized and shaped to be coupleably received in the seat track 16 to resist tensile loads, at least in part, via the tensile surface 32a. The shear flange 30a is sized and shaped to be coupleably received in the seat track 16 to resist shear loads, at least in part, via the side surface 31a.

The retention mechanism 24a is received in a retention recess 83a disposed in the seat track fitting body 23a. The retention mechanism 24a is generally configured to secure the seat track fitting 22a into the seat track 16 when the seat track fitting 22a is in an installed configuration, and also to prevent undesired rattling. In particular, the retention mechanism 24a includes a securement mechanism 33a and an anti-rattle mechanism 34a. The securement mechanism 33a includes a fastener 35a, a plunger 36a, one or more coupling plate(s) 37a, and first and second biasing devices 38a, 39a, e.g., springs. The one or more coupling plate(s) 37a is coupled to the plunger 36a, and includes a bolt aperture 85a, through which the fastener 35a extends. In this manner, translational movement of the fastener 35a, e.g., up-down via rotation of a head of the fastener 35a, causes the plunger 36a to move therewith in a same direction until a desired position, which may be defined or restricted by, for example, a stop surface, is reached. The first biasing device 38a is coupled to the plunger 36a and is generally configured to urge the plunger 36a away from or out of the retention recess 83a. The second biasing device 39a is coupled to the fastener 35a and is sized and shaped to urge the fastener 35a and the coupling plate 37a away from or out of the retention recess 83a.

The anti-rattle mechanism 34a includes a securing device 40a that is threadedly coupled to the fastener 35a and is also received in the retention recess 83a. The securing device 40a includes first and second flanges 41a, 42a that are axially spaced apart. The first and second flanges 41a, 42a are generally sized and shaped to clampingly couple the seat track fitting 22a to the seat track 16 to prevent rattling after installation. The anti-rattle mechanism 34a also includes rattle biasing device 43a, e.g., a spring. The rattle biasing device 43a is generally sized and shaped to urge the securing device 40a away from or out of the retention recess 83a, in a manner which allows for movement of the fastener 35a relative to the securing device 40a.

With reference to FIGS. 10-13 and continued reference to FIGS. 1 and 2 and 19-24, the seat track fitting 22b is generally similar to the seat track fitting 22a but includes certain variations. The seat track fitting 22b includes a seat track fitting body 23b and a retention mechanism 24b. The seat track fitting body 23b includes a central flange 25b that has a substantially triangular shape and includes a payload aperture 26b that extends through a lug portion 27b. In general, the central flange 25b can have other sizes, shapes and forms that may be selected appropriately based on a payload component that has to be coupled to the seat track fitting 22b. Similarly, the size, shape, and positioning of the payload aperture 26b can be selected appropriately based on the payload component that has to be coupled to the seat track fitting 22b.

The seat track fitting body 23b includes a plurality of spaced apart shear pads 28b. The shear pads 28b are generally similar to the shear pads 28a, and therefore will not be described in detail. As can be seen from FIGS. 10-13, the shear pads 28b include an integrally formed tensile flange 29b and a shear flange 30b, and are generally similar to the shear pads 28a.

The retention mechanism 24b is received in a retention recess 83b disposed in the seat track fitting body 23b. The retention mechanism 24b is generally configured to secure the seat track fitting 22b into the seat track 16 when the seat track fitting 22b is in an installed configuration, and also to prevent undesired rattling. In particular, the retention mechanism 24b includes a securement mechanism 33b and an anti-rattle mechanism 34b. The securement mechanism 33b includes a lever 35b, a plunger 36b, a shaft 37b, a pin 88b that pivotably couples the lever 35b to the seat track fitting body 23b. The securement mechanism 33b includes first and second biasing devices 38b, 39b, e.g., springs. The first biasing device 38b is coupled to the plunger 36b and urges the plunger 36b away from or out of the retention recess 83b. The second biasing device 39b is coupled to the shaft 37b and urges the shaft 37b away from or out of the retention recess 83b. The lever 35b includes first and second lever flanges 51b, 52b. The second biasing device 39b urges the shaft 37b into a recess formed by the second lever flange 52b. When shaft 37b is in position inside the recess of the second lever flange 52b, rotation of lever 35b in a first rotary direction R1 is prevented, which in effect latches lever 35b into position. To unlatch lever 35b, a tool may be inserted into lever aperture 200b, which depresses shaft 37b, thus freeing lever 35b to rotate in the first rotary direction R1.

As illustrated in FIGS. 10-13, the lever flange 51b is positioned adjacent to an upper surface of the plunger 36b. In this manner, pivotable movement of the lever 35b causes translation movement of the plunger 36b. The securement mechanism 33b also includes a fastener 55b. A head portion 56b of the fastener 55b secures the lever 35b. A shaft portion of the fastener 55b is coupled to the anti-rattle mechanism 34b. In particular, the anti-rattle mechanism 34b includes a plurality of spring washers 57b, a securement member 58b, and a nut 59b. The spring washers 57b are positioned between a flange of the securement member 58b and the nut 59b. Thus, to account for tolerances in manufacturing and assembly, the nut 59b can be loosened or tightened about the shaft portion of the fastener 55b to clamp the seat track fitting 22b against the seat track 16 to prevent rattling during use.

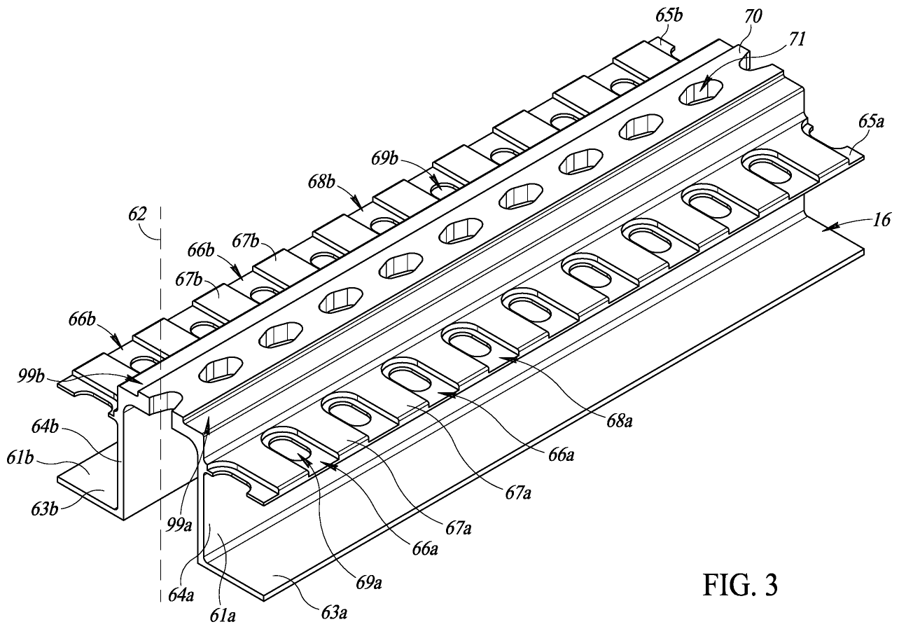

The seat track 16 is generally configured to be coupleable to the seat track fittings 22a, 22b, floor panels 20, floor beams 14, etc., in an efficient and robust manner. FIGS. 3-5 illustrate the seat track 16 in more detail. As shown in FIGS. 3-5, the seat track 16 includes a pair of chord flanges 61a, 61b that have a generally L-shaped cross section, although other shapes, sizes, and forms are within the scope of the disclosed subject matter. The chord flange 61a is a mirror image of the chord flange 61b relative to a central vertical axis 62. Each chord flange 61a, 61b includes a lower flange 63a, 63b and an upstanding flange 64a, 64b. The seat track 16 includes a pair of retention flanges 65a, 65b that extend outwardly from the upstanding flanges 64a, 64b. The retention flange 65b is a mirror image of the retention flange 65a relative to the central vertical axis 62, and thus, in the interest of brevity, only the retention flange 65a will be described in more detail.

As Illustrated in FIGS. 3-5, each retention flange 65a, 65b includes a plurality of spaced apart retention recesses 66a, 66b that partially extend through the retention flanges 65a, 65b. The retention recesses 66a, 66b, in this manner, define a plurality of retention tabs 67a, 67b and retention surfaces 68a, 68b. A plurality of arcuate-shaped apertures 69a, 69b extend through the retention surfaces 68a, 68b.

The seat track 16 includes a base flange 70 that extends between the upstanding flanges 64a, 64b. A pair of panel recesses 99a, 99b partially extends through the base flange 70 to define a substantially hat-shaped cross section of the base flange 70. As illustrated in FIGS. 3-5, the base flange 70 includes a plurality of spaced apart fitting apertures 71. Each fitting aperture 71 has a diamond-shaped profile, which is sized and shaped to receive therein shear pads, e.g., shear pads 28a, 28b, of seat track fittings, e.g., seat track fittings 22a, 22b, and securement mechanisms, e.g., securement mechanisms 33a, 33b, or portions thereof, such as for example plungers 36a, 36b. In particular, the diamond-shaped aperture advantageously provides a wedge-type interface for the coupleable seat track fittings, e.g., seat track fittings 22a, 22b, at a forward end of the diamond-shape, when attaching the seat track fittings. Similarly, at a rear end of the diamond-shape, a plunger of the seat track fitting, e.g., plungers 36a, 36b, can be inserted to secure the seat track fittings. Such an arrangement and configuration eases installation of seat track fittings in an efficient and robust manner.

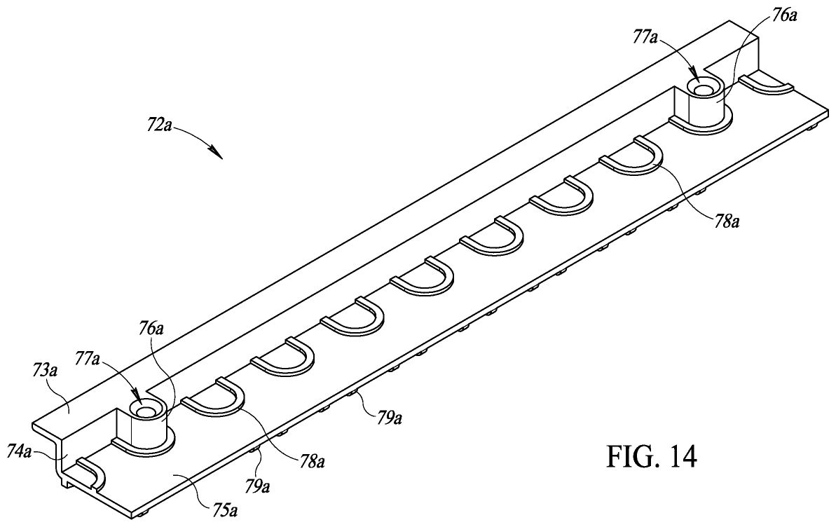

As described above, the flooring system 10, according to various embodiments or implementations described herein, reduces fasteners that are used to construct an aircraft flooring grid 11. For example, the flooring system 10 includes a pair of edge panels 72a, 72b that couple floor panels 20 to the seat track 16. The edge panels 72a, 72b couple the floor panels 20 to the seat track 16 in a manner that reduces or mitigates the requirement to use numerous fasteners to couple the floor panels 20 to the seat track 16. As illustrated in FIG. 1, the edge panel 72b is a mirror image of the edge panel 72a. Thus, in the interest of brevity, FIGS. 14-17 illustrate edge panel 72a in more detail; however, upon review of the disclosed subject matter, it should be clear that edge panel 72b includes similar features.

With reference to FIGS. 14-17 and continued reference to FIGS. 1-2 and 19-24, the edge panel 72a includes a generally z-shaped cross-sectional profile, although other shapes, sizes, and forms are within the scope of the disclosed subject matter. The edge panel 72a includes a connecting flange 73a, a web 74a extending perpendicularly from the connecting flange 73a, and panel flange 75a extending perpendicularly from the web 74a. One or more clip members 76a extend outwardly from the web 74a and include a substantially cylindrical shape. A fastening aperture 77a extends through the one or more clip members 76a and the panel flange 75a. One side of the panel flange 75a includes a plurality of spaced apart panel protrusions 78a. Another opposing side of the panel flange 75a includes a plurality of spaced apart track protrusions 79a. The track protrusions 79a have a substantially arcuate shape and are sized and shaped to be coupleably received in the retention recesses 66a between the retention tabs 67a.

The edge panels 72a, 72b couple the floor panels 20 and the seat track 16 together by reducing the number of fasteners needed. For example, the flooring system 10 includes one or more clip nut assemblies 80a, 80b (see, for example, FIG. 2). The clip nut assembly 80b is a mirror image of the clip nut assembly 80a, and thus only the clip nut assembly 80a will be described in more detail in the interest of brevity. As illustrated in FIGS. 1-2 and 19-24, one or more clip nut assemblies 80a couple the floor panel 20 to the seat track 16 via the edge panel 72a on one side of the seat track 16, and one or more clip nut assemblies 80b couple another floor panel 20 to the seat track 16 via the edge panel 72b on another side of the seat track 16. The clip nut assembly 80a includes a connecting flange 81a that has a substantially c-shaped cross section to define a panel cavity 92a, and a coupling member 93a. A coupling aperture 94a extends through the connecting flange 81a and into the coupling member 93a.

With reference to FIGS. 1, 2 and FIGS. 18-24, the flooring system 10 generally constructs an aircraft flooring grid 11 via coupling seat tracks 16, floor panels 20, floor beams 14, payload components, such as seats, via seat track fittings 22a, 22b, in an efficient, compact, and robust manner. The floor beams 14 generally extend laterally with respect to an aircraft fuselage longitudinal or roll axis, e.g., left-right direction, and can be coupled to the seat tracks 16 in a wide variety of ways. For example, in some implementations, the floor beams 14 can be positioned between the lower flanges 63a, 63b and upstanding flanges 64a, 64b of the seat tracks 16. In some implementations, upper and/or lower chords of the floor beams 14 may be coupled to corresponding lower flanges 63a, 63b and upstanding flanges 64a, 64b of the seat tracks 16. In some implementations, as illustrated in FIG. 1, an upper chord of the floor beam 14 can be coupled to the lower flanges 63a, 63b of the seat track 16.

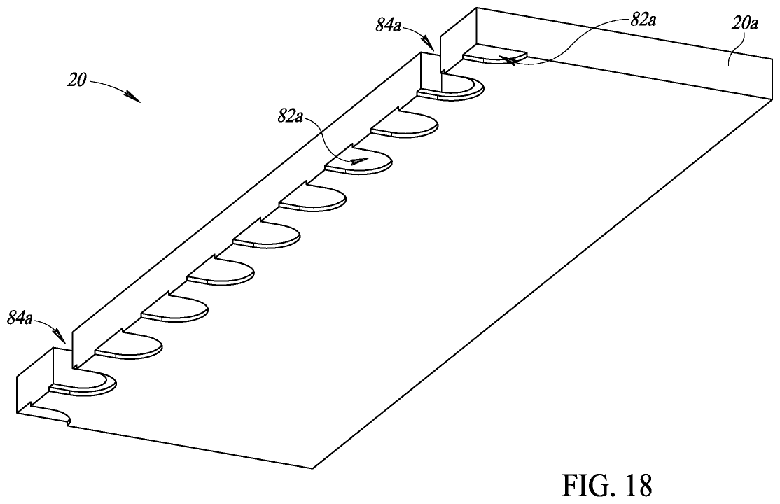

Each of the floor panels 20 are coupled to the seat track 16 via the edge panels 72a, 72b. In particular, the floor panels 20 can comprise floor panel 20a, 20b, which are mirror images of each other. As illustrated in FIG. 18, where only the floor panel 20a is illustrated, in the interest of brevity, the floor panel 20a includes a plurality of spaced apart panel recesses 82a that partially extend through the floor panel 20a from a lower surface thereof. The panel recesses 82a are sized and shaped to receive therein the panel protrusions 78a of the edge panel 72a. The floor panel 20a further includes one or more arcuate shaped clip recesses 84a that extend therethrough. Each clip recess 84a is sized and shaped to receive therethrough the clip member 76a of the edge panel 72a. Again, as described above, the floor panel 20b is a mirror image of the floor panel 20a, and thus includes similar features.

With specific reference to FIGS. 1 and 19-24, and continued reference to FIGS. 2-18, the floor panels 20a, 20b are coupled to the seat track 16 via the edge panels 72a, 72b. In particular, the floor panels 20a, 20b are coupled to corresponding edge panels 72a, 72b such that a side surface of the floor panels 20a, 20b is positioned adjacent to webs of the edge panels 72a, 72b, for example, webs 74a, 74b. The panel protrusions of corresponding edge panels 72a, 72b, for example, panel protrusions 78a, are coupleably received in the panel recesses of the corresponding floor panels, for example, panel recesses 82a. The clip members of corresponding edge panels 72a, 72b, for example, clip member 76a, extend through clip recesses of corresponding floor panels 20a, 20b, for example, clip recess 84a. Fasteners, e.g., panel fastener 86, extend through corresponding clip members of the edge panels 72a, 72b, for example, clip members 76a, and the panel flanges of the edge panels 72a, 72b, for example, panel flange 75a. The fasteners, e.g., panel fastener 86, couple to the coupling members of corresponding clip nut assemblies 80a, 80b, for example, coupling member 93a.

The clip nut assemblies 80a, 80b and the edge panels 72a, 72b are coupled to corresponding retention flanges 65a, 65b of the seat track 16. In particular, the track protrusions of corresponding edge panels 72a, 72b, for example, track protrusions 79a, are received in retention recesses 66a, 66b disposed in the retention flanges 65a, 65b, such that the track protrusions, for example, track protrusions 79a, are surrounded by corresponding retention tabs 67a, 67b. One or more of the retention recesses 66a, 66b, however, receive corresponding connecting flanges of the clip nut assemblies 80a, 80b, for example, connecting flange 81a. In particular, panel cavities of the clip nut assemblies 80a, 80b, for example, panel cavity 92a, receives therein the retention flanges 65a, 65b of the seat track 16, between the retention tabs 67a, 67b. Again, the fasteners, e.g., panel fastener 86, extend through corresponding clip members of the edge panels 72a, 72b, for example, clip members 76a, the panel flanges of the edge panels 72a, 72b, for example, panel flange 75a, the arcuate-shaped apertures 69a, 69b, and couple to the coupling members of corresponding clip nut assemblies 80a, 80b, for example, coupling member 93a. In this manner, the floor panels 20 are coupled to the seat track 16 in a simplified and effective manner that reduces the number of fasteners that are typically required to couple floor panels 20 to seat tracks 16. Moreover, in such an arrangement and configuration, the shear loads that are to be reacted by the flooring system 10, are primarily reacted by the track protrusions, for example, track protrusions 79a, being received in retention recesses of the edge panels, for example, retention recesses 66a, 66b, rather than using fasteners.

As described above, the seat track 16 coupleably receives one or more of seat track fittings, e.g., seat track fittings 22a, 22b, that couple to payload components, such as aircraft seats. For example, in one implementation, the seat track fittings 22a can be coupled to the seat track 16. In other implementations, the seat track fittings 22b can be coupled to the seat track 16. In other implementations, a combination of seat track fittings 22b can be coupled to the seat track 16. In general, as described above, the base flange 70 of the seat track 16 includes a plurality of spaced apart fitting apertures 71. Each fitting aperture 71 has a diamond-shape, which is sized and shaped to receive therein shear pads, e.g., shear pads 28a, 28b, of seat track fittings, e.g., seat track fittings 22a, 22b, and securement mechanisms, e.g., securement mechanisms 33a, 33b, or portions thereof, such as, for example, plungers 36a, 36b.

In particular, as the shear pads, for example, shear pads 28a, 28b, are received in the base flange 70 via the fitting apertures 71, the seat track fittings, e.g., seat track fittings 22a, 22b, are translated a certain distance in a longitudinal direction (i.e., forward-aft direction of an aircraft fuselage) until the side surfaces, e.g., side surfaces 31a, 31b, abut internal surfaces of the base flange 70 surrounding the fitting apertures 71. As the side surfaces abut internal surfaces of the base flange 70, tensile surfaces of the seat track fittings, e.g., tensile surfaces 32a, 32b, abut an outside surface of the base flange 70. At such a position, the seat track fittings, e.g., seat track fittings 22a, 22b, are in an installed position, e.g., installed to the seat track 16. Thereafter, securement mechanisms of the seat track fittings, e.g., securement mechanisms 33a, 33b, can be actuated to secure the seat track fittings to the seat track 16.

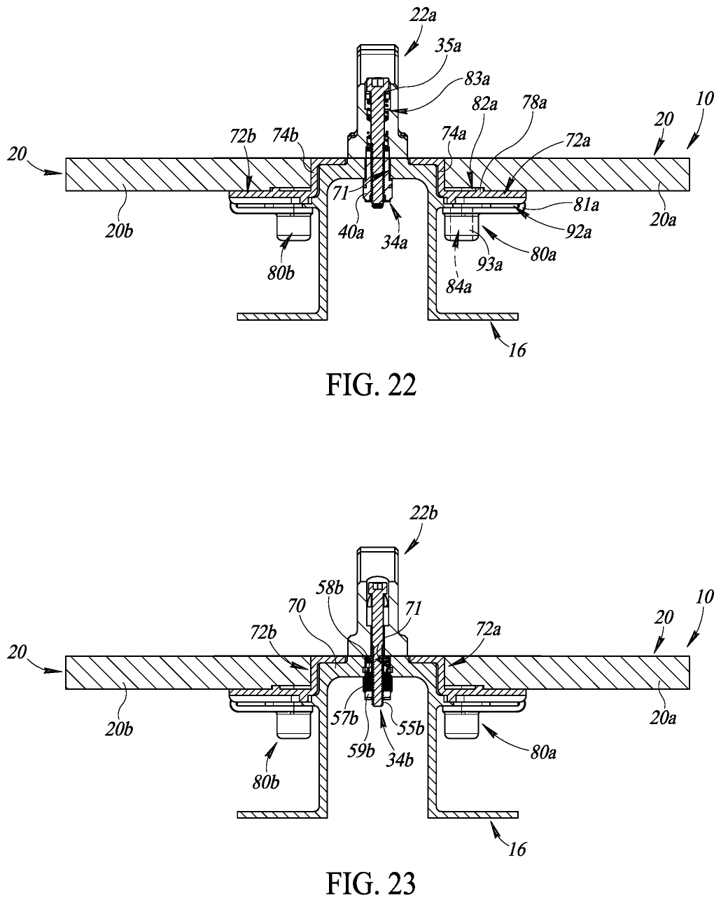

For example, in an implementation of a flooring system 10 that includes seat track fitting 22a, as shown for example in more detail in FIGS. 9 and 22, fastener 35a can be rotated to cause the plunger 36a to move into the fitting aperture 71 via movement of the coupling plate 37a. In addition, such translational movement of the fastener 35a actuates the anti-rattle mechanism 34a. In particular, as the fastener 35a is rotated, such causes the first and second flanges 41a, 42b of securing device 40a to clampingly couple the seat track fitting 22a to the seat track 16, and secure the seat track fitting 22a to the base flange 70 of the seat track 16 and also prevent rattling after installation.

In an implementation of a flooring system 10 that includes seat track fitting 22b, such as, for example, illustrated in detail in FIGS. 13 and 23, the lever 35b can be rotated in the second rotary direction R2, which causes the first lever flange 51b to drive the plunger 36b into the fitting aperture 71 of the base flange 70 of the seat track 16 and secure the seat track fitting 22b to the seat track 16. Moreover, if desired, the anti-rattle mechanism 34b is simultaneously actuated by rotating the lever 35b, lifting fastener 55b, causing the spring washers 57b to be compressed, which causes the nut 59b and the securement member 58b to clamp the seat track fitting 22b against the base flange 70 of the seat track 16.

The above-described method can be reversed during disassembly in order to uninstall, unsecure, and remove the seat track fittings, e.g., seat track fittings 22a, 22b, from the seat track 16. For example, as described above, a tool may be inserted into lever aperture 200b, which depresses shaft 37b, thus unlatching or otherwise freeing lever 35b to rotate in the first rotary direction R1, and which rotation of the lever 35b in the first rotary direction R1 can cause the plunger 36b to be translatingly moved out of the fitting aperture 71 of the base flange 70 of the seat track 16. Thereafter, the seat track fitting 22b can be translated in the longitudinal direction, opposite to the direction in which the seat track fitting 22b was moved for securement, which allows the shear pads 28b to be in a position within the fitting aperture 71 such that the seat track fitting 22b may be removed from the seat track 16. In a similar manner, for example, fastener 35a can be rotated to cause the plunger 36a to move out of the fitting aperture 71 via movement of the coupling plate 37a when the fastener 35a is rotated in a direction opposite to the rotary direction of installation. Such movement of the fastener 35a causes the first and second flanges 41a, 42a to unclamp the seat track fitting 22a from the seat track 16. Again, the seat track fitting 22a can be translated in the longitudinal direction, opposite to the direction in which the seat track fitting 22a was moved for securement, which allows the shear pads 28a to be in a position within the fitting aperture 71 such that the seat track fitting 22a may be removed from the seat track 16.

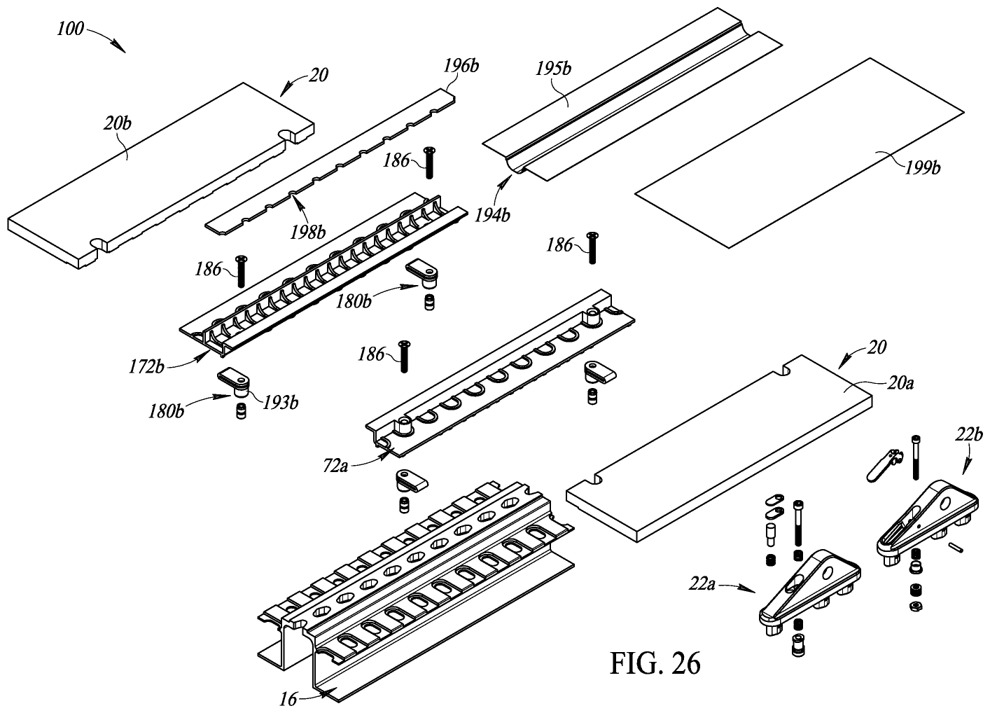

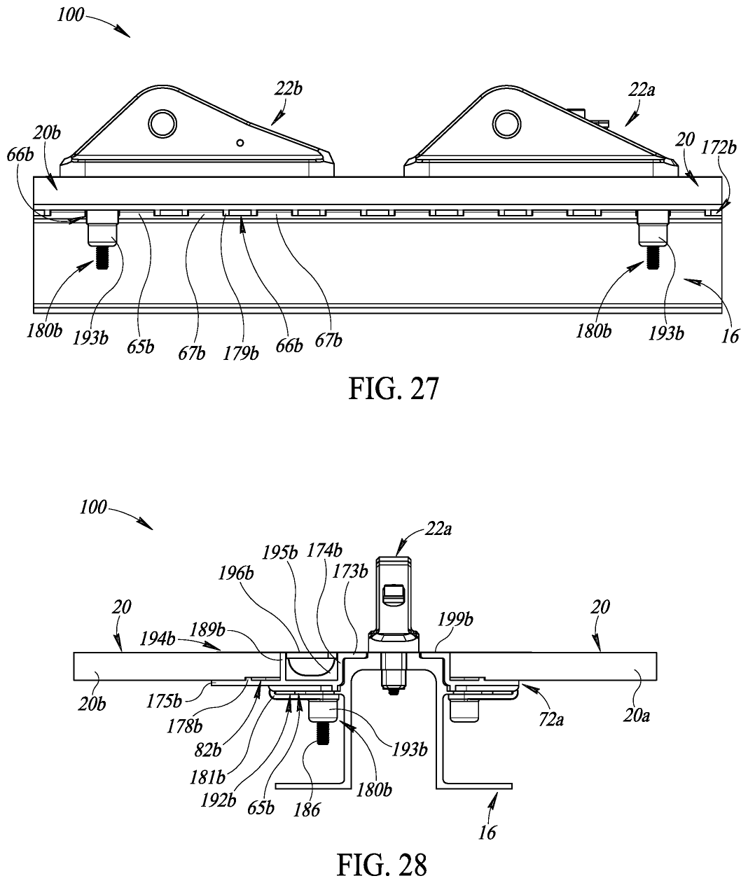

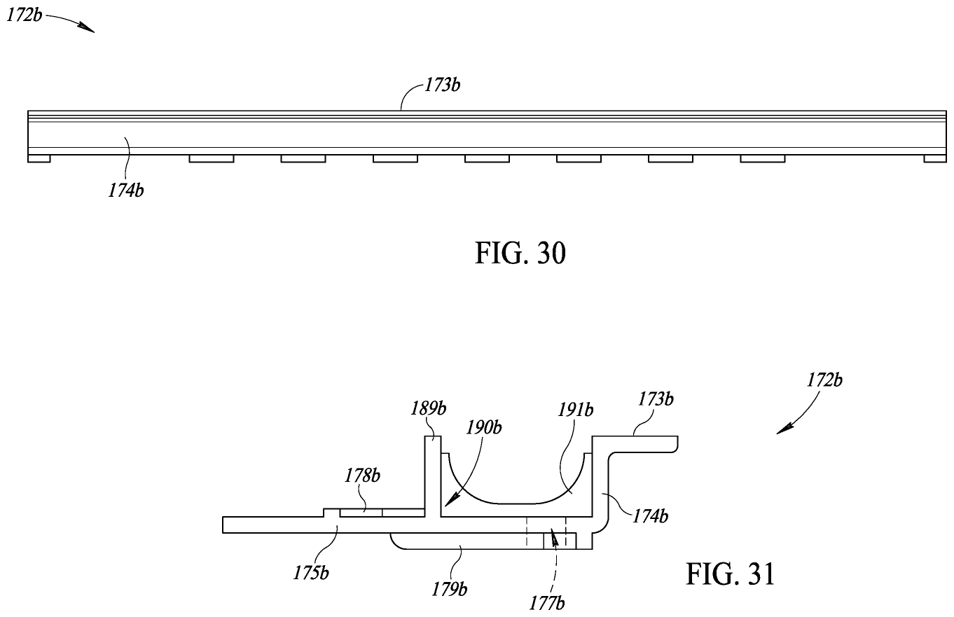

FIGS. 25-31 illustrate a flooring system 100 or portions thereof, according to another example, non-limiting implementation. The flooring system 100 is generally similar to the flooring system 10. For example, the flooring system 100 includes a plurality of floor beams 14, which are spaced apart (only one shown for clarity of illustration and description), and extending laterally with respect to an aircraft fuselage longitudinal or roll axis, e.g., left-right direction, and a plurality of seat tracks 16 (only one shown for clarity of illustration and description) extending longitudinally with respect to the aircraft fuselage, e.g., forward-aft direction or parallel to the fuselage longitudinal or roll axis, to define a flooring grid. A plurality of floor panels 20 are secured to the seat tracks 16. The floor panels 20, e.g., floor panels 20a, 20b, may extend in the lateral direction between a pair of adjacent seat tracks 16 or may extend laterally between multiple adjacent seat tracks 16. The flooring system 100, however, provides certain variations. For example, as illustrated in FIGS. 25-31, the flooring system 100 includes an edge panel 72a that is coupled to the floor panel 20a and the seat track 16 in a manner similar to the manner illustrated in FIGS. 1-24. However, the flooring system 100 includes a wiring edge panel 172b. The wiring edge panel 172b is generally sized and shaped to allow various wiring components and other supporting structures to be extend therethrough. Such a wiring edge panel 172b can advantageously eliminate floor wire raceways that add to assembly, manufacturing, installation costs, time, and weight of the aircraft flooring grid, e.g., flooring grid 11.

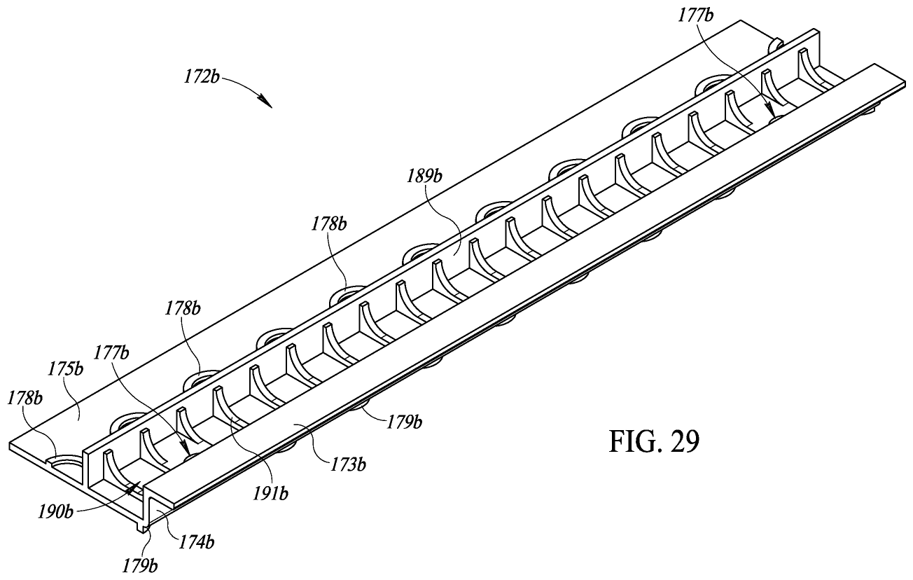

As illustrated in FIGS. 29-31 in more detail, the wiring edge panel 172b includes a connecting flange 173b, a web 174b extending perpendicularly from the connecting flange 173b, and panel flange 175b extending perpendicularly from the web 174b. One side of the panel flange 175b includes a plurality of spaced apart panel protrusions 178b that have a substantially arcuate shape. Another opposing side of the panel flange 175b includes a plurality of spaced apart track protrusions 179b. The track protrusions 179b have a substantially arcuate shape, and are sized and shaped to be coupleably received in retention recesses 66b between the retention tabs 67b of seat track 16. The panel protrusions 178b are sized and shaped to be coupleably received in panel recesses 82b of the floor panel 20b. The wiring edge panel 172b provides a variation in that it includes a channel flange 189b. The channel flange 189b protrudes outwardly from the panel flange 175b to define a wiring channel 190b. The wiring channel 190b is generally sized and shaped to receive therethrough wiring components and other supporting structures that may be routed through the wiring channel 190b. In some implementations, the wiring channel 190b includes stiffeners 191b that generally have a c-shaped cross-sectional profile and extend between the channel flange 189b and the web 174b. The stiffeners 191b, however, can have a wide variety of shapes, sizes, and forms, and are generally constructed to stiffen or strengthen the wiring edge panel 172b while providing spaces or openings for wiring components and other supporting structures to be routed through.

The panel flange 175b further includes one or more fastening aperture 177b that extend through the panel flange 175b. The fastening apertures 177b are sized and shaped to coupleably receive fasteners 186 that couple the floor panel 20b to the retention flange 65b of the seat track 16 via the wiring edge panel 172b and one or more clip nut assemblies 180b. The one or more clip nut assemblies 180b are generally similar to the clip nut assemblies 80a, 80b, but provide a variation in which the fasteners 186 extend through a coupling member 193b. For example, in some implementations, a side surface of the floor panel 20b is positioned adjacent to channel flange 189b of the wiring edge panel 172b. The side surface may, in some implementations, be adhered or bonded to the channel flange 189b. In some implementations, however, other fastening structures are to couple the floor panel 20b to the channel flange 189b are also within the scope of the disclosed subject matter. For example, in some implementations, one or more fasteners may couple the floor panel 20b to the panel flange 175b of the wiring edge panel 172b. As described above, the panel protrusions 178b are coupleably received in the panel recesses 82b of the floor panel 20b.

As described above, the track protrusions 179b of wiring edge panel 172b are received in retention recesses 66b disposed in the retention flanges 65b such that the track protrusions 179b are surrounded by corresponding retention tabs 67b. One or more of the retention recesses 66b, however, receive corresponding connecting flanges 181b of the clip nut assemblies 180b. In particular, panel cavities 192b of the clip nut assemblies 180b receive therein the retention flanges 65b of the seat track 16, between the retention tabs 67b. The fasteners 186 extend through fastening apertures 177b of wiring edge panel 172b, the panel flange 175b and coupling members 193b to couple the wiring edge panel 172b to the seat track 16 and the floor panel 20b.

The flooring system 100 also optionally includes a wiring cover assembly 194b. The wiring cover assembly 194b may include sealing tape 195b and a wiring cover plate 196b. The sealing tape 195b is shaped to be seated in the wiring channel 190b of the wiring edge panel 172b. The wiring cover plate 196b has a generally rectangular cross-sectional profile that is sized and shaped to be seated in the wiring channel 190b between the channel flange 189b and the web 174b. The wiring cover plate 196b includes optional wiring apertures 198b that are sized and shaped to allow wiring components or other supporting structures to be routed into or out of the wiring channel 190b.

In some implementations, the flooring system 100 optionally includes tape member 199b. The tape member 199b is generally configured to provide corrosion resistance to the flooring system 100 and is coupled to upper surfaces of the floor panels 20a, 20b, edge panels 172b, 72a, base flange 70 of seat tracks 16, wiring cover plate 196b, etc. In general, the tape member 199b is generally coupled to components of the flooring system 100 that may be exposed to an environment of the aircraft flooring system 100. In some implementations, the tape member 199b may comprise MYLAR, or other corrosion resistant metallic tape materials.

Moreover, the various embodiments or implementations described above can be combined to provide further embodiments. For example, in some implementations, a flooring system may include a wiring edge panel 172b coupled to floor panel 20b and seat track 16 on one side thereof, and another wiring edge panel that is a mirror image of the wiring edge panel 172b coupled to floor panel 20a and seat track 16 on another side thereof. In some implementations, a mirror image of the wiring edge panel 172b may be coupled to floor panel 20a and seat track 16 on one side thereof, and edge panel 72b may be coupled to the floor panel 20b and seat track 16 on another side thereof. In some implementations, the optional tape member 199b may be included in the flooring system 10; for example, the optional tape member 199b may be coupled to upper surfaces of the floor panels 20a, 20b, edge panels 72a, 72b, and base flange 70 of the seat track. Again, as described above, in some implementations, the flooring systems may include one or more of seat track fittings 22a, 22b, or various combinations thereof.

Moreover, one or more of the various components of the aircraft flooring systems described herein can comprise aluminum, titanium, steel, carbon-fiber reinforced plastic, or other composite and plastic materials. For example, in some implementations, the seat track, seat track fittings, and various components thereof can comprise aluminum, titanium, steel or various plastic materials. For example, in some implementations, the edge panels can comprise aluminum, titanium, steel or various plastic materials. For example, the floor panels can comprise aluminum or titanium sheet metal, carbon-fiber reinforced plastic, or other composite and plastic materials.

These and other changes can be made to the embodiments or implementations in light of the above-detailed description. In general, in the following claims, the terms used should not be construed to limit the claims to the specific embodiments or implementations disclosed in the specification and the claims, but should be construed to include all possible embodiments or implementations along with the full scope of equivalents to which such claims are entitled. Accordingly, the claims are not limited by the disclosure.

1. An aircraft flooring system, comprising:
a floor beam;
a seat track having a base flange, the base flange including a plurality of apertures, one or more of the apertures having a diamond-shaped profile;
a seat track fitting coupleable to the seat track via the diamond-shaped profile of the plurality of apertures of the seat track;
a first floor panel; and
an edge panel that is sized and shaped to couple the first floor panel to the seat track.

2. The aircraft flooring system of claim 1 wherein the seat track fitting includes one or more shear pads, each of the one or more shear pads sized and shaped to be received through the apertures of the seat track.

3. The aircraft flooring system of claim 2 wherein the shear pads are integrally formed with a body of the seat track fitting, and each of the shear pads including a tensile flange and a shear flange, the tensile flange sized and shaped to couple to the base flange of the seat track and resist tensile loads of the aircraft flooring system, and the shear flange sized and shaped to couple to the base flange of the seat track and resist shear loads of the aircraft flooring system.

4. The aircraft flooring system of claim 1 wherein the edge panel includes a panel flange, the panel flange including a plurality of arcuate-shaped panel protrusions that are sized and shaped to couple to the floor panel via corresponding panel recesses disposed in the first floor panel.

5. The aircraft flooring system of claim 1 wherein the seat track includes a retention flange, the retention flange including a plurality of retention recesses that partially extend through the retention flange, the retention recesses sized and shaped to define tabs that are positioned adjacent to the retention recesses.

6. The aircraft flooring system of claim 5 wherein the edge panel includes at least one arcuate-shaped track protrusion, the track protrusion sized and shaped to be coupleably received in the retention recess disposed in the retention flange of the seat track.

7. The aircraft flooring system of claim 1, further comprising:
one or more clip nut assemblies, the one or more clip nut assemblies sized and shaped to secure the first floor panel to the seat track.

8. The aircraft flooring system of claim 1 wherein the seat track fitting includes a retention mechanism, the retention mechanism configured to secure the seat track fitting to the seat track when the seat track fitting is in an installed configuration.

9. The aircraft flooring system of claim 1, further comprising:
a second floor panel coupled to the seat track and positioned adjacent to the first floor panel; and
a wiring edge panel that is sized and shaped to couple the second floor panel to the seat track.

10. The aircraft flooring system of claim 9 wherein the wiring edge panel has an arcuate-shaped channel that is sized and shaped to receive one or more wiring components.

11. An aircraft flooring system, comprising:
a seat track having:
a base flange;
a first chord flange and a second chord flange, the first chord flange being a mirror image of the second chord flange relative to a central vertical axis of the seat track, the first chord flange and the second chord flange coupled to the base flange;
a first retention flange and a second retention flange, the first retention flange being a mirror image of the second retention flange relative to the central vertical axis of the seat track, the first retention flange and the second retention flange each protruding outwardly from the respective first chord flange and the second chord flange;
a first floor panel;
a second floor panel;
a first edge panel that is sized and shaped to couple the first floor panel to the first retention flange of the seat track; and
a second edge panel that is sized and shaped to couple the second floor panel to the second retention flange of the seat track.

12. The aircraft flooring system of claim 11 wherein at least the first floor panel includes a plurality of panel recesses, and at least the first edge panel includes a plurality of panel protrusions, each of the panel protrusions sized and shaped to be coupleably received in a corresponding panel protrusion of the first floor panel.

13. The aircraft flooring system of claim 11 wherein at least the first retention flange of the seat track includes a plurality of retention recesses that partially extend through the first retention flange, and at least the first edge panel includes a plurality of track protrusions, at least some of the retention recesses sized and shaped to coupleably receive the track protrusions of the first edge panel.

14. The aircraft flooring system of claim 11 wherein the base flange includes a plurality of spaced apart diamond-shaped apertures.

15. The aircraft flooring system of claim 14, further comprising:
a seat track fitting including a plurality of shear pads, each of the shear pads sized and shaped to be coupleably received through a corresponding diamond-shaped aperture of the base flange of the seat track.

16. A seat track of an aircraft flooring system, the seat track comprising:
a base flange having a plurality of diamond-shaped apertures;
a first chord flange including a first upstanding flange and a first lower flange, the first upstanding flange extending from the base flange;
a second chord flange including a second upstanding flange and a second lower flange, the second upstanding flange extending from the base flange;
a first retention flange extending outwardly from the first upstanding flange; and
a second retention flange extending outwardly from the second upstanding flange.

17. The seat track of claim 16 wherein the first chord flange is a mirror image of the second chord flange about a central vertical axis of the seat track.

18. The seat track of claim 16 wherein the first and second retention flanges each include a plurality of retention recesses that are spaced apart, each retention recess partially extending through the respective first and second retention flanges to define a plurality of retention tabs, a pair of retention tabs being positioned adjacent to at least some of the retention recesses.

19. The seat track of claim 18 wherein each of the retention recesses defines a retention surface, an arcuate-shaped aperture extending therethrough.

20. An edge panel of an aircraft flooring system, comprising:
a connecting flange;
a web flange extending from the connecting flange; and
a panel flange extending outwardly from an end of the web flange, the panel flange including a first surface and a second surface, the first surface of the panel flange including a plurality of spaced apart panel protrusions protruding outwardly from the first surface.

21. The edge panel of claim 20 wherein the second surface of the panel flange includes a plurality of spaced apart track protrusions protruding outwardly from the second surface.

22. The edge panel of claim 21 wherein the panel protrusions and the track protrusions have a substantially arcuate shape.

23. The edge panel of claim 20, further comprising:
one or more clip members extending outwardly from the web flange, the one or more clip members having a substantially cylindrical shape.

24. The edge panel of claim 20, further comprising:
a channel flange protruding outwardly from the panel flange, the channel flange positioned adjacent to the web flange to define a channel sized and shaped to provide access to one or more wiring components.

25. The edge panel of claim 24, further comprising:
one or more stiffeners positioned in the channel.

26. A method of construction of an aircraft flooring grid, the method comprising:
providing at least one floor beam;
coupling at least one seat track to the floor beam, the at least one seat track including a base flange, the base flange including a plurality of apertures, one or more of the apertures having a diamond-shaped profile;
coupling at least one edge panel to the at least one seat track;
coupling at least one floor panel to the at least one seat track via the at least one edge panel; and
coupling a seat track fitting to the base flange of the at least one seat track via one or more of the apertures of the seat track having the diamond-shaped profile.

27. The method of claim 26 wherein coupling the seat track fitting comprises:
moving one or more shear pads of the seat track fitting through the apertures of the at least one seat track;
translating the seat track fitting in a longitudinal direction; and
actuating a retention mechanism of the seat track fitting.

28. The method of claim 26 wherein coupling the at least one edge panel to the at least one seat track comprises positioning at least one track protrusion of the least one edge panel in a retention recess of a retention flange of the at least one seat track.

29. The method of claim 26 wherein coupling the at least one floor panel to the at least one seat track via the at least one edge panel comprises positioning a panel protrusion of the at least one edge panel in a panel recess of the at least one floor panel.

30. The method of claim 26, further comprising:
coupling another edge panel to the at least one seat track; and
coupling another floor panel to the at least one seat track via the another edge panel.
